(19) United States
(12) Patent Application Publication
(10) Pub. No.: US 2025/0349454 A1
(43) Pub. Date: Nov. 13, 2025

(54) INDUCTOR COMPONENT

(71) Applicant: Murata Manufacturing Co., Ltd., Kyoto-fu (JP)

(72) Inventors: Kenji TOYOSHIMA, Nagaokakyo-shi (JP); Taiga KATO, Nagaokakyo-shi (JP); Katsufumi SASAKI, Nagaokakyo-shi (JP); Yoshimasa YOSHIOKA, Nagaokakyo-shi (JP)

(73) Assignee: Murata Manufacturing Co., Ltd., Kyoto-fu (JP)

(21) Appl. No.: 19/191,799

(22) Filed: Apr. 28, 2025

(30) Foreign Application Priority Data
May 7, 2024 (JP) 2024-075354

(51) Int. Cl. H01F 27/00; H01F 5/00; H01F 5/04; H01F 37/00

(52) U.S. Cl. CPC H01F 27/006; H01F 5/003; H01F 5/04; H01F 37/005

(57) ABSTRACT

An inductor component includes a coil wiring line having a meandering shape meandering in a first direction and extending in a second direction crossing the first direction; first and second external terminals; a first connection conductor that extends in a third direction crossing the first direction and the second direction and that is connected to the first external terminal and the coil wiring line; and a second connection conductor that extends in the third direction and that is connected to the second external terminal and the coil wiring line. When viewed in the third direction, a coil center line is between a first center line and a second center line, the coil center line being a center of the coil wiring line in the first direction and extending parallel to the second direction.

### CROSS-REFERENCE TO RELATED APPLICATION

This application claims benefit of priority to Japanese Patent Application No. 2024-075354, filed May 7, 2024, the entire content of which is incorporated herein by reference.

### BACKGROUND

### Technical Field

The present disclosure relates to an inductor component in which a coil wiring line having a meandering shape is provided in a main body.

### Background Art

Japanese Unexamined Patent Application Publication No. 2022-26745 discloses an example of such an inductor component in which a coil wiring line having a meandering shape is provided in a main body.

In the inductor component disclosed in Japanese Unexamined Patent Application Publication No. 2022-26745, two end portions of a coil wiring line having a meandering shape are connected, via vertical wiring lines, to respective external terminals provided on a first main surface of the inductor component. The coil wiring line extends, in the short-side direction of the first main surface, from one end portion toward the other end portion thereof in the short-side direction while meandering in the long-side direction of the first main surface.

### SUMMARY

In the inductor component disclosed in Japanese Unexamined Patent Application Publication No. 2022-26745, the coil wiring line having a meandering shape meanders in the long-side direction of the first main surface other than the two end portions in the short-side direction of the first main surface. On the other hand, the coil wiring line does not meander at the two end portions in the short-side direction of the first main surface. Thus, spaces where the coil wiring line is not provided are formed in the vicinities of the vertical wiring lines in the inductor component. As a result, the inductance acquisition efficiency of the inductor component may be reduced.

Accordingly, the present disclosure provides an inductor component capable of inhibiting a reduction in inductance acquisition efficiency.

An inductor component according to an aspect of the present disclosure includes a main body; a coil wiring line that is provided in the main body and that has a meandering shape meandering in a first direction and extending in a second direction crossing the first direction; a first external terminal and a second external terminal provided on an outer surface of the main body; a first connection conductor that is provided in the main body, that extends in a third direction crossing the first direction and the second direction, and that is connected to the first external terminal and the coil wiring line; and a second connection conductor that is provided in the main body, that extends in the third direction, and that is connected to the second external terminal and the coil wiring line. When viewed in the third direction, a coil center line is located between a first center line and a second center line, the coil center line being a center of the coil wiring line in the first direction and extending parallel to the second direction, the first center line being a center of the first connection conductor in the first direction and extending parallel to the second direction, the second center line being a center of the second connection conductor in the first direction and extending parallel to the second direction.

According to the present disclosure, it is possible to provide an inductor component capable of inhibiting a reduction in inductance acquisition efficiency.

### BRIEF DESCRIPTION OF THE DRAWINGS

FIG. 1 is a schematic external perspective view of an inductor component according to an embodiment of the present disclosure;

FIG. 2 is a schematic plan view of a coil wiring line of the inductor component according to the embodiment of the present disclosure;

FIG. 3 is a schematic sectional view illustrating section III-III in FIG. 1;

FIG. 4 is a schematic sectional view illustrating a method for manufacturing the inductor component according to the embodiment of the present disclosure;

FIG. 5 is a schematic sectional view illustrating a step subsequent to that in FIG. 4 of the method for manufacturing the inductor component according to the embodiment of the present disclosure;

FIG. 6 is a schematic sectional view illustrating a step subsequent to that in FIG. 5 of the method for manufacturing the inductor component according to the embodiment of the present disclosure;

FIG. 7 is a schematic sectional view illustrating a step subsequent to that in FIG. 6 of the method for manufacturing the inductor component according to the embodiment of the present disclosure;

FIG. 8 is a schematic sectional view illustrating a step subsequent to that in FIG. 7 of the method for manufacturing the inductor component according to the embodiment of the present disclosure;

FIG. 9 is a schematic sectional view illustrating a step subsequent to that in FIG. 8 of the method for manufacturing the inductor component according to the embodiment of the present disclosure;

FIG. 10 is a schematic sectional view illustrating a step subsequent to that in FIG. 9 of the method for manufacturing the inductor component according to the embodiment of the present disclosure;

FIG. 11 is a schematic sectional view illustrating a step subsequent to that in FIG. 10 of the method for manufacturing the inductor component according to the embodiment of the present disclosure;

FIG. 12 is a schematic sectional view illustrating a step subsequent to that in FIG. 11 of the method for manufacturing the inductor component according to the embodiment of the present disclosure;

FIG. 13 is a schematic sectional view illustrating a step subsequent to that in FIG. 12 of the method for manufacturing the inductor component according to the embodiment of the present disclosure;

FIG. 14 is a schematic sectional view illustrating a step subsequent to that in FIG. 13 of the method for manufacturing the inductor component according to the embodiment of the present disclosure;

FIG. 15 is a schematic plan view of a coil wiring line of an inductor component according to a modification example of the embodiment of the present disclosure;

FIG. 16 is a schematic plan view of a coil wiring line of an inductor component according to a modification example of the embodiment of the present disclosure;

FIG. 17 is a schematic plan view of a coil wiring line of an inductor component according to a modification example of the embodiment of the present disclosure;

FIG. 18 is a schematic plan view of a coil wiring line of an inductor component according to a modification example of the embodiment of the present disclosure;

FIG. 19 is a schematic plan view of a coil wiring line of an inductor component according to a modification example of the embodiment of the present disclosure; and

FIG. 20 is a schematic plan view of a coil wiring line of an inductor component according to a modification example of the embodiment of the present disclosure.

### DETAILED DESCRIPTION

Examples of the present disclosure will be described below with reference to the accompanying drawings. The following description is essentially merely an example and is not intended to limit the present disclosure and the application and use of the present disclosure. In addition, the drawings are schematic, and, for example, size ratios therein do not necessarily coincide with actual ones. In addition, in the following description, terms that mean specific directions or positions (for example, terms including “up”, “down”, “right”, “left”, “forward”, or “backward”) are used as appropriate. However, such terms that mean specific directions or positions are used to facilitate understanding of the present disclosure with reference to the drawings, and the meanings of these terms do not limit the technical scope of the present disclosure.

### Embodiment

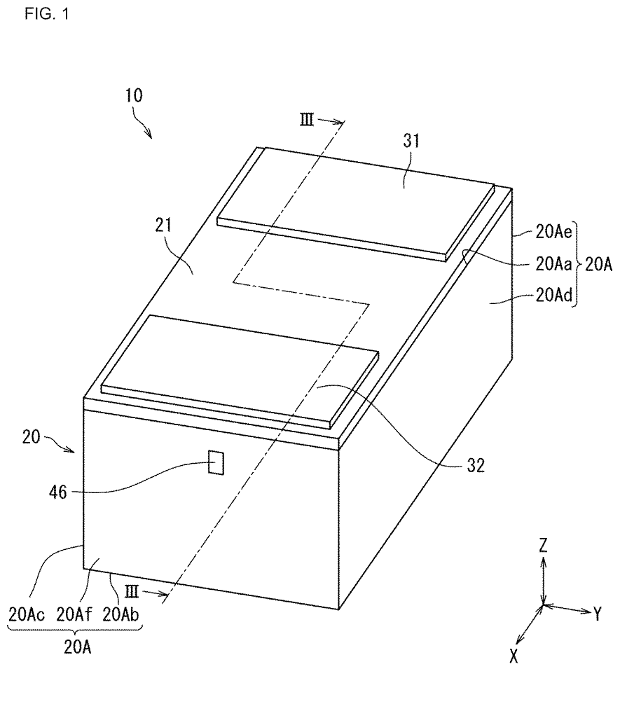

FIG. 1 is a schematic external perspective view of an inductor component according to an embodiment of the present disclosure. As illustrated in FIG. 1, an inductor component 10 according to the embodiment of the present disclosure includes a main body 20, an external insulating layer 21, a first external terminal 31, and a second external terminal 32.

The main body 20 has a cuboid shape. In the present embodiment, outer surfaces 20A of the main body 20 include an upper surface 20Aa, which faces upward, a lower surface 20Ab, which faces downward, a front side surface 20Ac, a rear side surface 20Ad, a left side surface 20Ae, and a right side surface 20Af, which connect the upper surface 20Aa and the lower surface 20Ab. The front side surface 20Ac faces forward. The rear side surface 20Ad faces backward. The left side surface 20Ae faces leftward. The right side surface 20Af faces rightward. That is, the upper surface 20Aa and the lower surface 20Ab face in opposite directions, the front side surface 20Ac and the rear side surface 20Ad face in opposite directions, and the left side surface 20Ae and the right side surface 20Af face in opposite directions. In the drawings, the X direction, the Y direction, and the Z direction are represented by arrows. In the present embodiment, the X direction is a left-right direction, the Y direction is a front-rear direction, and the Z direction is an up-down direction. The X direction, the Y direction, and the Z direction are orthogonal to each other. The shape of the main body 20 is not limited to a cuboid shape and may be a different shape such as a cylindrical shape.

In the present embodiment, the upper surface 20Aa and the lower surface 20Ab cross (in the present embodiment, are orthogonal to) the Z direction. The front side surface 20Ac, the rear side surface 20Ad, the left side surface 20Ae, and the right side surface 20Af are parallel to the Z direction.

The main body 20 contains a magnetic material. This will be described below in detail. The main body 20 contains a magnetic powder (magnetic material) and a resin containing the magnetic powder. For example, the resin is an epoxy resin, a phenolic resin, a liquid crystal polymer resin, a polyimide resin, an acrylic resin, or an organic insulating material made of a mixture of these substances. For example, the magnetic powder is made of a FeSi alloy such as a FeSiCr alloy, a FeCo alloy, a Fe alloy such as a NiFe alloy, or an amorphous alloy thereof. Thus, compared with a configuration in which the main body 20 is made of only ferrite, direct current superposed characteristics can be improved by the magnetic powder, and pieces of the magnetic powder are insulated from each other by the resin, resulting in a reduction in loss (iron loss) at a high frequency. The main body 20 may be made of, for example, ferrite or a sintered body of magnetic powder and may thus be made without an organic resin. That is, the entire main body 20 may be made of a magnetic material. Needless to say, as described above, a part of the main body 20 may be made of a magnetic material, and the other part of the main body 20 may be made of a material different from the magnetic material.

In the present embodiment, the median grain size D50 of the magnetic material contained in the main body 20 is equal to or less than 10 μm. The median grain size D50 of the magnetic material contained in the main body 20 may be more than 10 μm.

The external insulating layer 21 is laminated on the upper surface 20Aa of the main body 20. The external insulating layer 21 is laminated on a partial region of the upper surface 20Aa. The first external terminal 31 and the second external terminal 32 are provided on the portion excluding the partial region. The external insulating layer 21 is made of an insulator. For example, the external insulating layer 21 is made of acrylate and silicon dioxide (SiO₂).

The first external terminal 31 and the second external terminal 32 are provided on at least one of the outer surfaces 20A of the main body 20. In the present embodiment, the first external terminal 31 and the second external terminal 32 are provided on the upper surface 20Aa of the main body 20. The first external terminal 31 is provided on the left part (one side in the X direction) of the upper surface 20Aa. The second external terminal 32 is provided on the right part (the other side in the X direction) of the upper surface 20Aa. The first external terminal 31 and the second external terminal 32 are made of conductive materials. In the present embodiment, the first external terminal 31 and the second external terminal 32 each have a three-layer structure in which Cu, which has a low electrical resistance and excellent stress resistance, Ni, which has excellent corrosion resistance, and Au, which has excellent wettability and excellent reliability, are arranged in this order from the inside to the outside.

The first external terminal 31 may be provided on a part of the upper surface 20Aa other than the left part. The second external terminal 32 may be provided on a part of the upper surface 20Aa other than the right part. The first external terminal 31 and the second external terminal 32 may be provided on a part of the main body 20 other than the upper surface 20Aa.

In the present embodiment, the first external terminal 31 and the second external terminal 32 are provided on the same surface (upper surface 20Aa) of the main body 20. However, the first external terminal 31 and the second external terminal 32 may be provided on different surfaces of the main body 20. For example, whereas the first external terminal 31 may be provided on the upper surface 20Aa, the second external terminal 32 may be provided on the lower surface 20Ab.

In the present embodiment, each of the first external terminal 31 and the second external terminal 32 is provided on one surface (upper surface 20Aa) of the main body 20. However, each of the first external terminal 31 and the second external terminal 32 may be provided on and extend over a plurality of surfaces of the main body 20. For example, the first external terminal 31 may be provided on and extend over the entire left side surface 20Ae and the left part of each of the upper surface 20Aa, the lower surface 20Ab, the front side surface 20Ac, and the rear side surface 20Ad. In addition, for example, the second external terminal 32 may be provided on and extend over the entire right side surface 20Af and the right part of each of the upper surface 20Aa, the lower surface 20Ab, the front side surface 20Ac, and the rear side surface 20Ad.

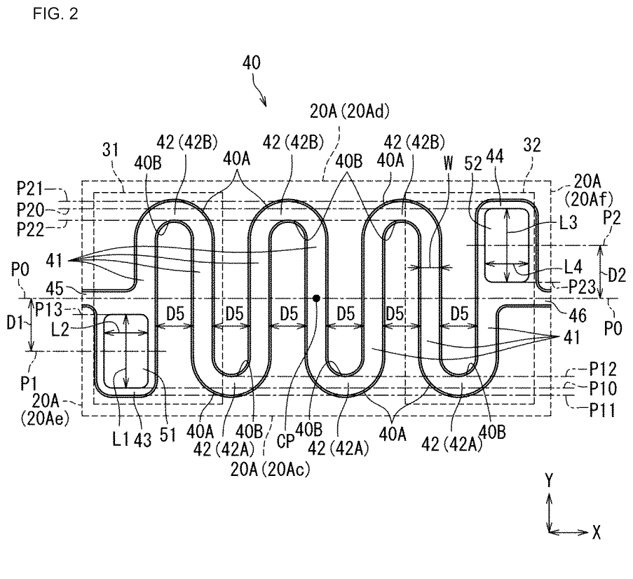

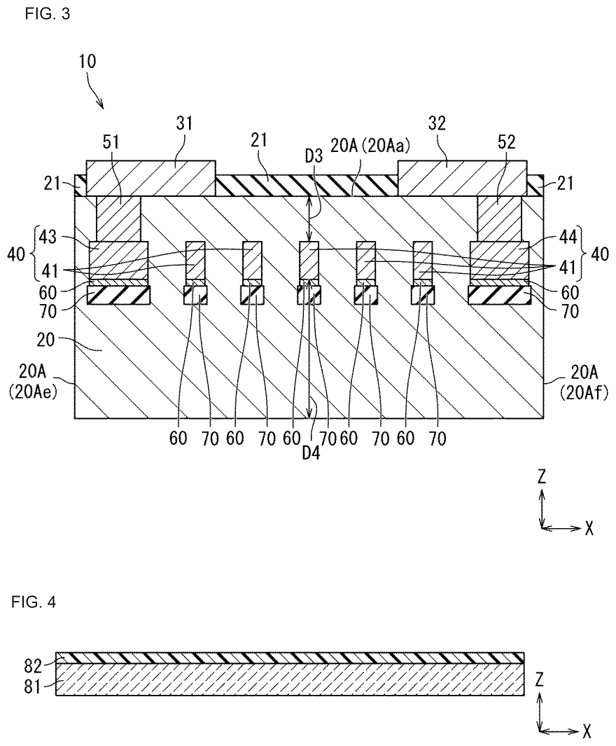

FIG. 2 is a schematic plan view of a coil wiring line of the inductor component according to the embodiment of the present disclosure. FIG. 3 is a schematic sectional view illustrating section III-III in FIG. 1.

As illustrated in FIGS. 2 and 3, the inductor component 10 includes a coil wiring line 40, a first connection conductor 51, a second connection conductor 52, a seed layer 60, and an internal insulating layer 70.

The coil wiring line 40, the first connection conductor 51, the second connection conductor 52, the seed layer 60, and the internal insulating layer 70 are provided in the main body 20 and are interposed between the upper surface 20Aa and the lower surface 20Ab. The upper surface 20Aa is an example of a first surface. The lower surface 20Ab is an example of a second surface.

The coil wiring line 40, the first connection conductor 51, and the second connection conductor 52 are made of a conductive material. In the present embodiment, the coil wiring line 40, the first connection conductor 51, and the second connection conductor 52 are made of a conductive material that is a metal material having a low electrical resistance, such as Cu, Ag, Au, or Al.

As illustrated in FIG. 2, the coil wiring line 40 has a meandering shape. The coil wiring line 40 extends in the X direction orthogonal to the Y direction while meandering in the Y direction. The Y direction is an example of a first direction. The X direction is an example of a second direction. The direction in which the coil wiring line 40 extends is not limited to the X direction. It is sufficient that the coil wiring line 40 extends in a direction crossing the Y direction.

The coil wiring line 40 includes a plurality of extending portions 41, each of which extends in the Y direction, and turning portions 42, each of which connects corresponding two adjacent extending portions 41 of the plurality of extending portions 41.

The turning portions 42 include curved portions 42A, which curve convexly toward one side (forward) in the Y direction, and curved portions 42B, which curve convexly toward the other side (backward) in the Y direction. In the present embodiment, the coil wiring line 40 includes seven extending portions 41 and six turning portions 42. In addition, in the present embodiment, three of the six turning portions 42 are the curved portions 42A, and the remaining three of the six turning portions 42 are the curved portions 42B. Each of the number of the extending portions 41 and the number of the turning portions 42 may be any number. In addition, each of the number of the curved portions 42A and the number of the curved portions 42B may be any number.

The coil wiring line 40 includes pads 43 and 44. The pad 43 is provided at one end portion of the coil wiring line 40. The pad 44 is provided at the other end portion of the coil wiring line 40. In the present embodiment, the pads 43 and 44 are formed so as to be wider than the other part of the coil wiring line 40 when viewed in the Z direction.

The coil wiring line 40 extends from the pad 43 to the pad 44. The extending portions 41 and the turning portions 42 are alternately provided in the path from the pad 43 to the pad 44. In addition, of the turning portions 42, the curved portions 42A and the curved portions 42B are alternately provided. In the present embodiment, the path from the pad 43 to the pad 44 of the coil wiring line 40 is as follows. That is, in the path, the pad 43, the extending portion 41, the curved portion 42B, the extending portion 41, the curved portion 42A, the extending portion 41, the curved portion 42B, the extending portion 41, the curved portion 42A, the extending portion 41, the curved portion 42B, the extending portion 41, the curved portion 42A, the extending portion 41, and the pad 44 are arranged in this order.

The position of the pad 43 is not limited to the one end portion of the coil wiring line 40, and the position of the pad 44 is not limited to the other end portion of the coil wiring line 40. That is, the pad 43 can be provided at any position in the coil wiring line 40.

As illustrated in FIGS. 1 and 2, the coil wiring line 40 includes branch wiring lines 45 and 46. The branch wiring line 45 is exposed at the left side surface 20Ae of the main body 20. The branch wiring line 46 is exposed at the right side surface 20Af of the main body 20. The branch wiring lines 45 and 46 are used for, for example, power supply from the outside of the inductor component 10.

As illustrated in FIG. 3, the first connection conductor 51 and the second connection conductor 52 extend in the Z direction. The Z direction is an example of a third direction. One end portion of the first connection conductor 51 in the Z direction (an upper end portion of the first connection conductor 51) is connected to the first external terminal 31. The other end portion of the first connection conductor 51 in the Z direction (a lower end portion of the first connection conductor 51) is connected to the pad 43. That is, the first connection conductor 51 is connected to the first external terminal 31 and the coil wiring line 40. One end portion of the second connection conductor 52 in the Z direction (an upper end portion of the second connection conductor 52) is connected to the second external terminal 32. The other end portion of the second connection conductor 52 in the Z direction (a lower end portion of the second connection conductor 52) is connected to the pad 44. That is, the second connection conductor 52 is connected to the second external terminal 32 and the coil wiring line 40.

The direction in which the first connection conductor 51 and the second connection conductor 52 extend is not limited to the Z direction. It is sufficient that the first connection conductor 51 and the second connection conductor 52 extend in a direction crossing the X direction and the Y direction. For example, the first connection conductor 51 may extend from the pad 43 to the first external terminal 31 in a direction inclined relative to the Z direction (in other words, obliquely upward).

In the present embodiment, as illustrated in FIG. 2, the first external terminal 31 has a larger area than the first connection conductor 51 when viewed in the Z direction but may be encompassed by the first connection conductor 51 when viewed in the Z direction. In addition, the second external terminal 32 has a larger area than the second connection conductor 52 when viewed in the Z direction but may be encompassed by the second connection conductor 52 when viewed in the Z direction.

As illustrated in FIG. 2, a maximum length L1 of the first connection conductor 51 in the Y direction, which is the direction in which the coil wiring line 40 meanders, is longer than a maximum length L2 of the first connection conductor 51 in the X direction, which is a direction from the pad 43 toward the pad 44. In the present embodiment, similarly to the first connection conductor 51, a maximum length L3 of the second connection conductor 52 in the Y direction is longer than a maximum length L4 of the second connection conductor 52 in the X direction.

In the present embodiment, the first connection conductor 51 and the second connection conductor 52 have rectangular shapes having four round vertexes when viewed in the Z direction. The shapes of the first connection conductor 51 and the second connection conductor 52 when viewed in the Z direction are not limited to such rectangular shapes having four round vertexes. For example, the vertexes of the first connection conductor 51 and the second connection conductor 52 do not have to be round. In addition, for example, the shapes of the first connection conductor 51 and the second connection conductor 52 may be shapes other than rectangular shapes, such as circular shapes or elliptical shapes when viewed in the Z direction. In addition, for example, the first connection conductor 51 and the second connection conductor 52 may have the same shape or size or different shapes or sizes when viewed in the Z direction.

When viewed in the Z direction, a coil center line P0, which is the center of the coil wiring line 40 in the Y direction and extends parallel to the X direction, is located between a first center line P1, which is the center of the first connection conductor 51 in the Y direction and extends parallel to the X direction, and a second center line P2, which is the center of the second connection conductor 52 in the Y direction and extends parallel to the X direction. In other words, in the Y direction, the coil center line P0 is located between the first center line P1 and the second center line P2. That is, the first center line P1 and the second center line P2 are located on the opposite sides of the coil center line P0 in the Y direction. Thus, the first connection conductor 51 is located at a position shifted from the coil center line P0 in the Y direction, and the second connection conductor 52 is located at a position that is shifted from the coil center line P0 in the Y direction and that is on the opposite side of the coil center line P0 in the Y direction from the first connection conductor 51.

The coil center line P0 is located midway between a position P11 and a position P21, which will be described later, in the Y direction. The first center line P1 is located midway between a position P10 and a position P13, which will be described later, in the Y direction. The second center line P2 is located midway between a position P20 and a position P23, which will be described later, in the Y direction.

When viewed in the Z direction, the first connection conductor 51 and the second connection conductor 52 are located outside the coil center line P0 in the Y direction. In other words, when viewed in the Z direction, the first connection conductor 51 and the second connection conductor 52 are not located on the coil center line P0 in the Y direction at all.

When viewed in the Z direction, the first connection conductor 51 and the second connection conductor 52 are located so as to be symmetrical relative to a coil center point CP. The coil center point CP is located at the center of the coil wiring line 40 in the X direction and the Y direction. In the present embodiment, the coil center point CP is located midway between the position P11 and the position P21 in the Y direction and midway between the left side surface 20Ae (left end of the coil wiring line 40) and the right side surface 20Af (right end of the coil wiring line 40) in the X direction.

When viewed in the Z direction, a distance D1 and a distance D2 are equal to each other. The distance D1 is a distance from the coil center line P0 to the first center line P1 in the Y direction. The distance D2 is a distance from the coil center line P0 to the second center line P2 in the Y direction.

The position P10 is located between the position P11 and a position P12 in the Y direction. The position P10 is located at the end farther from the coil center line P0 in the Y direction of two ends (the position P10 and the position P13) of the first connection conductor 51 in the Y direction. The position P10 is an example of a conductor end. The position P11 is a position farthest from the coil center line P0 in an outer peripheral edge 40A of the coil wiring line 40 on the same side of the coil center line P0 as the position P10. The position P11 is an example of a first position. The position P12 is a position farthest from the coil center line P0 in an inner peripheral edge 40B of the coil wiring line 40 on the same side of the coil center line P0 as the position P10. The position P12 is an example of a second position.

In the present embodiment, as described below in detail, the position P20 has a positional relationship in the coil wiring line 40 similar to that of the position P10. The position P20 is located between the position P21 and a position P22 in the Y direction. The position P20 is located at the end farther from the coil center line P0 in the Y direction of two ends (the position P20 and the position P23) of the second connection conductor 52 in the Y direction. The position P20 is an example of the conductor end. The position P21 is a position farthest from the coil center line P0 in an outer peripheral edge 40A of the coil wiring line 40 on the same side of the coil center line P0 as the position P20. The position P21 is an example of the first position. The position P22 is a position farthest from the coil center line P0 in an inner peripheral edge 40B of the coil wiring line 40 on the same side of the coil center line P0 as the position P20. The position P22 is an example of the second position.

As illustrated in FIG. 3, a distance D3 between the coil wiring line 40 and the upper surface 20Aa in the Z direction is shorter than a distance D4 between the coil wiring line 40 and the lower surface 20Ab in the Z direction. That is, the coil wiring line 40 is located closer to the upper surface 20Aa than the lower surface 20Ab in the Z direction.

As described above, as illustrated in FIG. 2, the coil wiring line 40 includes the turning portions 42 including the curved portions 42A and 42B.

The curved portions 42A are located on the opposite side of the coil center line P0 in the Y direction from the curved portions 42B. The coil wiring line 40 extends toward the one side (forward) in the Y direction and turns at the curved portion 42A toward the other side (backward) in the Y direction and extends toward the other side (backward) in the Y direction and turns at the curved portion 42B toward the one side (forward) in the Y direction.

As described above, in the present embodiment, three of the six turning portions 42 are the curved portions 42A, and the remaining three of the six turning portions 42 are the curved portions 42B. The number of turns of the coil wiring line 40 on the same side of the coil center line P0 as the first center line P1 in the Y direction is the number of turns at the curved portions 42A. The number of turns of the coil wiring line 40 on the same side of the coil center line P0 as the second center line P2 in the Y direction is the number of turns at the curved portions 42B. That is, the number of turns of the coil wiring line 40 on the same side of the coil center line P0 as the first center line P1 in the Y direction is three, and the number of turns of the coil wiring line 40 on the same side of the coil center line P0 as the second center line P2 in the Y direction is three. In other words, the number of turns of the coil wiring line 40 on each side of the coil center line P0 in the Y direction is three. From the above, the number of turns of the coil wiring line 40 on the same side of the coil center line P as the first center line P1 in the Y direction is equal to the number of turns of the coil wiring line 40 on the same side of the coil center line P0 as the second center line P2 in the Y direction. The number of turns of the coil wiring line 40 on each side of the coil center line P0 in the Y direction may be a number different from three, such as four.

As illustrated in FIG. 3, the seed layer 60 is located on the other side of the coil wiring line 40 in the Z direction (lower side of the coil wiring line 40). In other words, the coil wiring line 40 is laminated on the seed layer 60. The seed layer 60 is made of conductive materials. In the present embodiment, the seed layer contains titanium (Ti) and copper (Cu). The seed layer may contain titanium (Ti) and nickel (Ni). The seed layer 60 can be understood as a part of the coil wiring line. In this case, the coil wiring line has a two-layer structure including the seed layer 60 and an electrolytic plating layer (the coil wiring line 40)

The internal insulating layer 70 is located on the other side of the seed layer 60 in the Z direction (lower side of the seed layer 60). In other words, the seed layer 60 is laminated on the internal insulating layer 70. The internal insulating layer 70 is made of an insulating material not containing a magnetic substance. The internal insulating layer 70 is made of, for example, an organic resin such as an epoxy resin, a phenolic resin, a polyimide resin, a liquid crystal polymer, or a combination of these substances, a sintered body such as glass or alumina, or a thin film such as a silicon oxide film, a silicon nitride film, or a silicon oxynitride film.

The internal insulating layer 70 is provided to cover the other side of the coil wiring line 40 in the Z direction (lower side of the coil wiring line 40) with an insulator. On the other hand, one side of the coil wiring line 40 in the Z direction (upper side of the coil wiring line 40) is not covered with an insulator. That is, a part of the coil wiring line 40 facing the first external terminal 31 and the second external terminal 32 is not covered with an insulator. In addition, the sides (parts facing in directions orthogonal to the Z direction) of the coil wiring line 40 are not covered with an insulator. That is, parts of the coil wiring line 40 facing the front side surface 20Ac, the rear side surface 20Ad, the left side surface 20Ae, and the right side surface 20Af are also not covered with an insulator.

Dimensions of constituent elements of the inductor component 10 described above are as follows, for example.

The thickness (length in the Z direction) of the main body 20 is 10 μm. The thickness of the external insulating layer 21 is 7 μm. In each of the first external terminal 31 and the second external terminal 32, the thickness of a Cu layer is 5 μm, the thickness of a Ni layer is 5 μm, and the thickness of an Au layer is 0.01 μm. The thickness of the coil wiring line 40 is 45 μm. A width W (see FIG. 2) of the coil wiring line 40 when viewed in the Z direction is 70 μm. The thickness of each of the first connection conductor 51 and the second connection conductor 52 is 50 μm. The thickness of a layer made of titanium (Ti) of the seed layer 60 is 0.04 μm. The thickness of a layer made of copper (Cu) of the seed layer 60 is 0.10 μm. The thickness of the internal insulating layer 70 is 5 μm. The area of the main body 20 when viewed in the Z direction is 1570 μm (the X direction)×770 μm (the Y direction). The area of each of the first external terminal 31 and the second external terminal 32 when viewed in the Z direction is 440 μm (the X direction)×690 μm (the Y direction). The area of each of the first connection conductor 51 and the second connection conductor 52 when viewed in the Z direction is 150 μm (the X direction)×250 μm (the Y direction). The dimensions of the constituent elements are not limited to the dimensions described above.

In the present embodiment, a distance D5 (see FIG. 2) between two adjacent extending portions 41 of the coil wiring line 40 in the X direction is 5 times or more the median grain size D50 of the magnetic material contained in the main body 20. In other words, the median grain size D50 of the magnetic material contained in the main body 20 is ⅕ or less of the distance D5. As described above, in the present embodiment, the median grain size D50 of the magnetic material contained in the main body 20 is 10 μm or less. That is, when the median grain size D50 of the magnetic material contained in the main body 20 is 10 μm, the distance D5 is 50 μm or more.

In the present embodiment, the distance D3 (see FIG. 3) between the coil wiring line 40 and the upper surface 20Aa in the Z direction is 4 times or more the median grain size D50 of the magnetic material contained in the main body 20. As described above, the median grain size D50 of the magnetic material contained in the main body 20 is 10 μm or less. That is, when the median grain size D50 of the magnetic material contained in the main body 20 is 10 μm, the distance D3 is 40 μm or more.

### Method for Manufacturing Inductor Component

An example of a method for manufacturing the inductor component 10 according to the present embodiment will be described below with reference to FIGS. 4 to 14 and FIG. 3. FIGS. 4 to 14 are schematic sectional views illustrating a method for manufacturing the inductor component according to the present embodiment of the present disclosure.

First, as illustrated in FIG. 4, an insulating film 82 is formed on the entire surface of a support substrate 81. The support substrate 81 is made of ceramic such as ferrite or alumina. The insulating film 82 is made of a resin such as an epoxy resin or a polyimide resin.

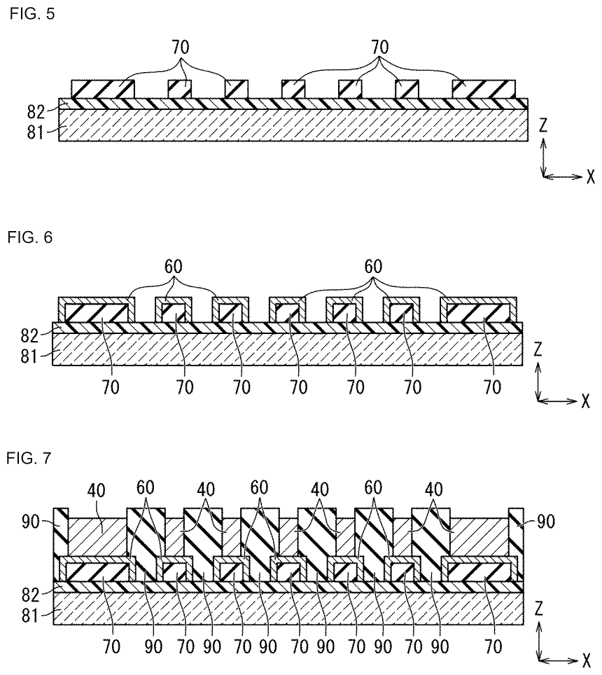

Next, as illustrated in FIG. 5, the internal insulating layer 70 is formed on a part of the insulating film 82. The internal insulating layer 70 has the same shape as the coil wiring line 40 when viewed in the Z direction.

Next, as illustrated in FIG. 6, the seed layer 60 is formed on the internal insulating layer 70.

Next, as illustrated in FIG. 7, the coil wiring line 40 is formed on the seed layer 60. This will be described below in detail. First, a dry film resist (DFR) 90 is laminated on the insulating film 82 and the seed layer 60. Next, the DFR 90 is exposed. Thus, a pattern having the same shape as the part other than the coil wiring line is transferred to a part of the DFR 90 immediately above the seed layer 60. Next, the DFR 90 is developed. Thus, a part of the DFR 90 to which the pattern is not transferred is removed, and the seed layer 60 is exposed at the place where the part of the DFR 90 is removed. Next, electrolytic plating is performed. Thus, a metal film is formed. This metal film is the coil wiring line 40.

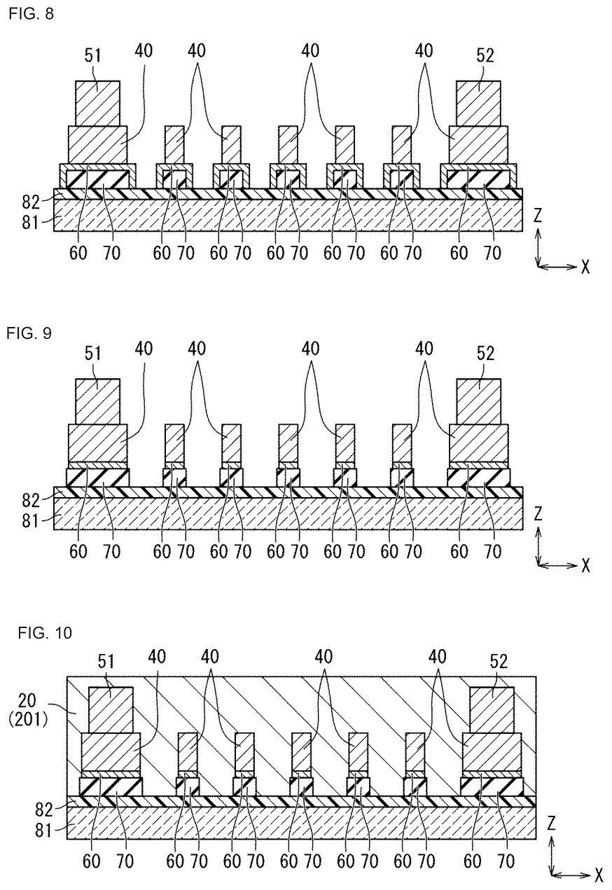

Next, as illustrated in FIG. 8, the first connection conductor 51 and the second connection conductor 52 are formed on the coil wiring line 40. The first connection conductor 51 and the second connection conductor 52 are formed as follows in a manner similar to the manner in which the coil wiring line 40 is formed. First, a DFR is laminated on the coil wiring line 40 and the DFR 90 in FIG. 7. Next, the DFR is exposed and developed, thus forming cavities having the same shapes as the first connection conductor 51 and the second connection conductor 52. Thereafter, electrolytic plating is performed. Thereafter, the DFR is removed. The first connection conductor 51 is formed on the pad 43 located at the one end portion of the coil wiring line 40. The second connection conductor 52 is formed on the pad 44 located at the other end portion of the coil wiring line 40.

Next, seed etching is performed. Thus, a part of the seed layer 60 exposed to the outside in FIG. 8 is removed. As a result, as illustrated in FIG. 9, only a part of the seed layer 60 covered with the coil wiring line 40 is left.

Next, as illustrated in FIG. 10, a first magnetic layer 201 is formed on the insulating film 82 by a known method such as thermocompression bonding of a magnetic composite film made of a metal filler and a resin. Thus, the internal insulating layer 70, the seed layer 60, the coil wiring line 40, the first connection conductor 51, and the second connection conductor 52 are covered with the first magnetic layer 201.

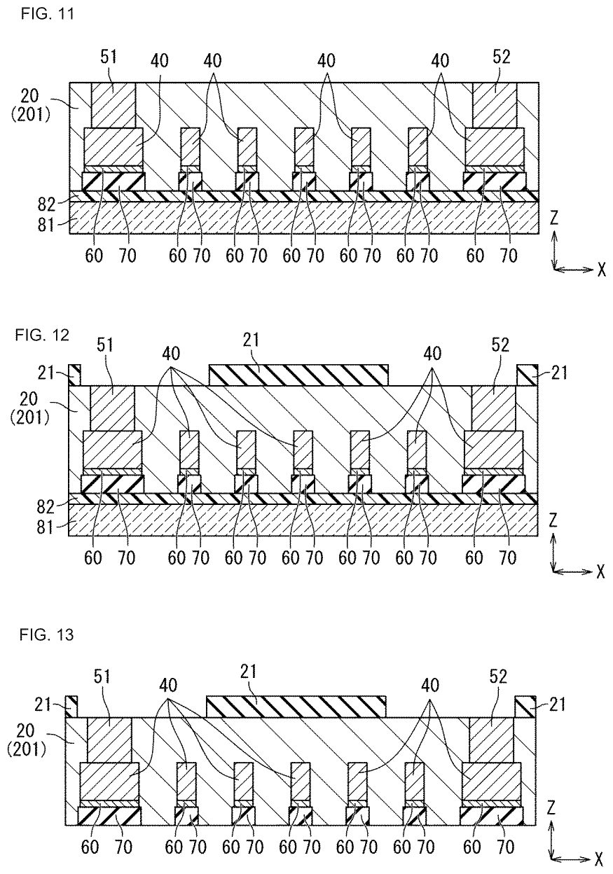

Next, as illustrated in FIG. 11, the first magnetic layer 201 is ground by a known method such as mechanical polishing. Thus, the first connection conductor 51 and the second connection conductor 52 are exposed.

Next, as illustrated in FIG. 12, a solder resist (the external insulating layer 21) is formed on the first magnetic layer 201. The external insulating layer 21 is formed by a known method such as exposure and development. The external insulating layer 21 is formed on a part of the first magnetic layer 201.

Next, as illustrated in FIG. 13, the support substrate 81 and the insulating film 82 are removed by a known method such as mechanical polishing. Thus, the internal insulating layer 70 is exposed.

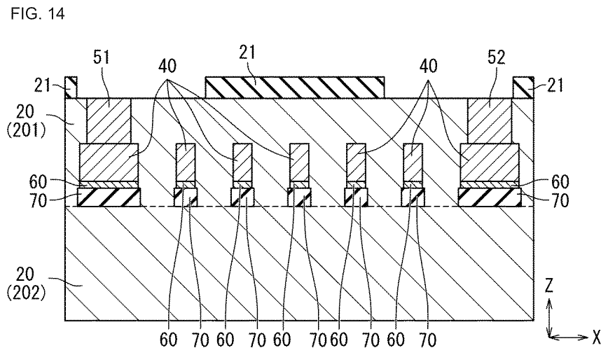

Next, as illustrated in FIG. 14, a second magnetic layer 202 is formed by a known method such as thermocompression bonding of a magnetic composite film made of a metal filler and a resin. The second magnetic layer 202 is formed so as to cover the exposed internal insulating layer 70. The first magnetic layer 201 and the second magnetic layer 202 form the main body 20. In FIG. 14, the boundary between the first magnetic layer 201 and the second magnetic layer 202 is represented by a dashed line. In FIG. 14, the thickness (length in the Z direction) of the second magnetic layer 202 is thicker than the thickness of the first magnetic layer 201. However, the thickness of the second magnetic layer 202 may be equal to or less than the thickness of the first magnetic layer 201.

Next, as illustrated in FIG. 3, the first external terminal 31 and the second external terminal 32 are formed by a known method such as plating. As a result, the inductor component 10 is completed. The first external terminal 31 and the second external terminal 32 are formed on respective parts of the first magnetic layer 201 where the external insulating layer 21 is not provided. The first external terminal 31 is connected to the exposed first connection conductor 51. The second external terminal 32 is connected to the exposed second connection conductor 52.

According to the present embodiment, the coil center line P0 is located between the first center line P1 and the second center line P2. That is, the first connection conductor 51 is shifted toward one side of the coil center line P0 in the Y direction, and the second connection conductor 52 is shifted toward the other side of the coil center line P0 in the Y direction. Thus, it is possible to extend the first connection conductor 51 toward one end of the coil wiring line 40 in the Y direction and to extend the second connection conductor 52 toward the other end of the coil wiring line 40 in the Y direction. Accordingly, it is possible to increase the meandering of the coil wiring line 40 in the Y direction at respective parts of the coil wiring line 40 connected to the first connection conductor 51 and the second connection conductor 52, that is, two end portions of the coil wiring line 40 in the X direction. As a result, it is possible to inhibit a reduction in the inductance acquisition efficiency of the inductor component 10.

According to the present embodiment, when viewed in the Z direction, the first connection conductor 51 and the second connection conductor 52 are located outside the coil center line P0 in the Y direction. Thus, it is possible to reduce the size of each of the first connection conductor 51 and the second connection conductor 52 and to increase the meandering of the coil wiring line 40 in the Y direction at the two end portions of the coil wiring line 40 in the X direction.

According to the present embodiment, the first connection conductor 51 and the second connection conductor 52 are located so as to be symmetrical to each other. Thus, when mounting the inductor component 10 on a different member such as a substrate, it is possible to improve flexibility in the orientation in which the inductor component 10 is mounted. This eliminates the need for attaching a direction mark to the main body 20, for example.

According to the present embodiment, the position P10 is located between the position P11 and the position P12. That is, the first connection conductor 51 extends to the vicinity of the end of the coil wiring line 40 in the Y direction. Thus, it is possible to increase the meandering of the coil wiring line 40 in the Y direction in the vicinity of the first connection conductor 51.

According to the present embodiment, the maximum length L1 of the first connection conductor 51 in the Y direction is longer than the maximum length L2 of the first connection conductor 51 in the X direction. That is, the first connection conductor 51 is long in the Y direction. Thus, it is possible to increase the meandering of the coil wiring line 40 in the Y direction in the vicinity of the first connection conductor 51. In addition, since the first connection conductor 51 is long in the Y direction, it is possible to increase the fixing strength of the first connection conductor 51 against a pressure applied on the main body 20 in the Y direction.

According to the present embodiment, the number of turns of the coil wiring line 40 on each side of the coil center line P0 in the Y direction is equal. This enables a magnetic flux generated when an electric current flows through the coil wiring line 40 to be symmetrical relative to the center of the coil wiring line 40. Thus, when mounting the inductor component 10 on a different member such as a substrate, it is possible to improve flexibility in the orientation in which the inductor component 10 is mounted.

According to the present embodiment, the distance D3 between the coil wiring line 40 and the upper surface 20Aa of the main body 20 in the Z direction is shorter than the distance D4 between the coil wiring line 40 and the lower surface 20Ab of the main body 20 in the Z direction. Thus, it is possible to locate the coil wiring line 40, in which an electric current flows to generate heat, close to the conductive first external terminal 31 and the conductive second external terminal 32. As a result, it is possible to improve heat dissipation from the inductor component 10.

According to the present embodiment, the first connection conductor 51 and the second connection conductor 52 extend in the Z direction. In this case, in the manufacturing process of the inductor component 10, the magnetic material may be difficult to fill in the vicinities of the first connection conductor 51 and the second connection conductor 52.

According to the present embodiment, the median grain size D50 of the magnetic material contained in the main body 20 is 10 (μm) or less. Thus, compared with a configuration in which the median grain size D50 of the magnetic material contained in the main body 20 is more than 10 μm, it is possible to increase the filling density of the magnetic material.

According to the present embodiment, the median grain size D50 of the magnetic material contained in the main body 20 is ⅕ or less of the distance D5 between two adjacent extending portions 41 of the coil wiring line 40 in the X direction. Thus, compared with a configuration in which the median grain size D50 of the magnetic material contained in the main body 20 is more than ⅕ of the distance, it is possible to increase the filling density of the magnetic material.

As a result, in the manufacturing process of the inductor component 10, it is possible to easily fill the magnetic material in the vicinities of the first connection conductor 51 and the second connection conductor 52.

### Modification Example

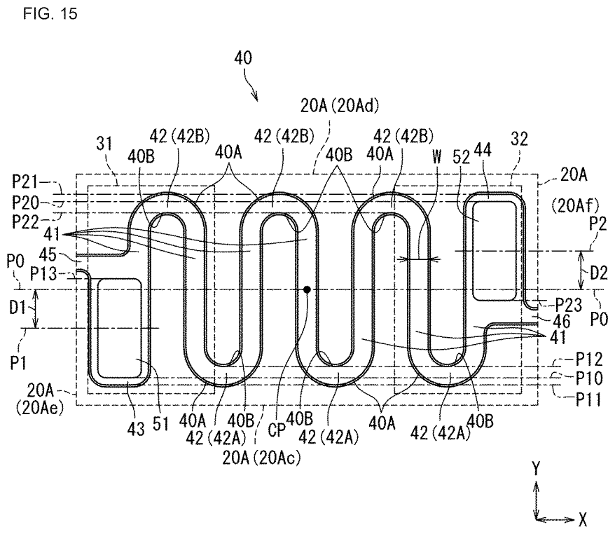

Various modification examples of the inductor component 10 will be described below with reference to FIGS. 15 to 20. Each of FIGS. 15 to 20 is a schematic plan view of a coil wiring line of an inductor component according to a modification example of the embodiment of the present disclosure.

In the configuration illustrated in FIG. 2, when viewed in the Z direction, the first connection conductor 51 and the second connection conductor 52 are located outside the coil center line P0 in the Y direction. However, as illustrated in FIG. 15, when viewed in the Z direction, the first connection conductor 51 and the second connection conductor 52 may be provided so as to cross the coil center line P0 in the Y direction. That is, when viewed in the Z direction, the first connection conductor 51 and the second connection conductor 52 do not have to be located outside the coil center line P0 in the Y direction.

Even in the configuration illustrated in FIG. 15, when viewed in the Z direction, the coil center line P0 is located between the first center line P1 and the second center line P2. Thus, in the configuration illustrated in FIG. 15, similarly to the configuration illustrated in FIG. 2, the first connection conductor 51 is located at a position shifted from the coil center line P0 in the Y direction, and the second connection conductor 52 is located at a position that is shifted from the coil center line P0 in the Y direction and that is on the opposite side of the coil center line P0 in the Y direction from the first connection conductor 51. In the configuration illustrated in FIG. 15, the distance D1 and the distance D2 are equal to each other.

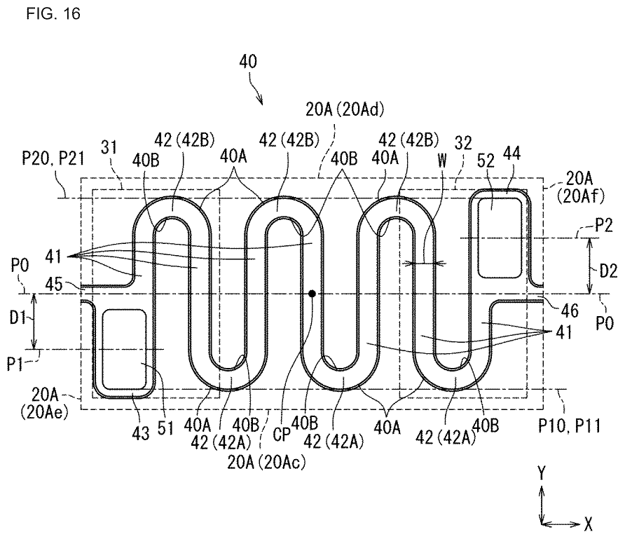

In the configuration illustrated in FIG. 2, in the Y direction, the position P10 is located between the position P11 and the position P12, and the position P20 is located between the position P21 and the position P22. However, the position P10 and the position P20 are not limited to the positions illustrated in FIG. 2. For example, as illustrated in FIG. 16, the position P10 and the position P11 may be the same position in the Y direction. In addition, for example, the position P20 and the position P21 may be the same position in the Y direction. The position P10 and the position P11 may be slightly different positions in the Y direction due to, for example, a tolerance. That is, the position P10 and the position P11 may be substantially the same position in the Y direction. The same applies to the position P20 and the position P21.

According to the modification example illustrated in FIG. 16, the first connection conductor 51 can extend to the end of the coil wiring line 40 in the Y direction. Thus, it is possible to increase the meandering of the coil wiring line 40 in the Y direction in the vicinity of the first connection conductor 51.

In the configuration illustrated in FIG. 2, when viewed in the Z direction, the first connection conductor 51 and the second connection conductor 52 are located so as to be symmetrical relative to the coil center point CP. However, when viewed in the Z direction, the first connection conductor 51 and the second connection conductor 52 may be located so as not to be symmetrical relative to the coil center point CP.

According to this modification example, the first connection conductor 51 and the second connection conductor 52 are located so as not to be symmetrical to each other. Thus, it is possible to improve flexibility in the position, size, and shape of each of the first connection conductor 51 and the second connection conductor 52. Accordingly, for example, when the first connection conductor 51 and the second connection conductor 52 are changed in position, size, or shape, it is possible to easily make fine adjustments to the inductance of the inductor component 10.

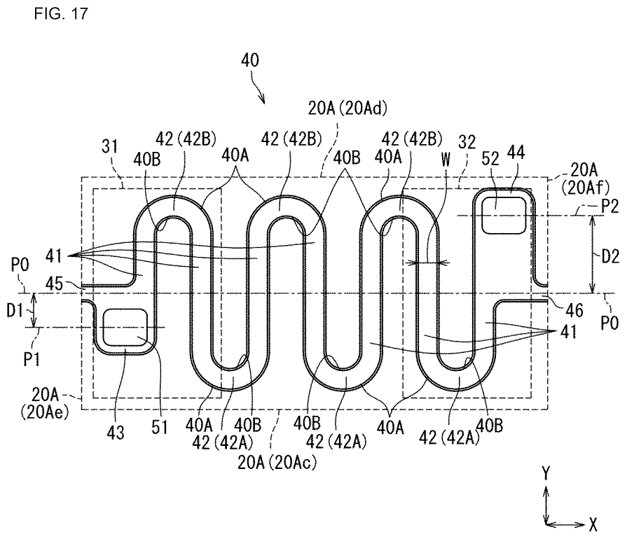

Examples in which the first connection conductor 51 and the second connection conductor 52 are located so as not to be symmetrical relative to the coil center point CP when viewed in the Z direction will be described below with reference to FIGS. 17 to 19.

As illustrated in FIG. 17, the distance D1 from the coil center line P0 to the first center line P1 in the Y direction may differ from the distance D2 from the coil center line P0 to the second center line P2 in the Y direction. In the configuration illustrated in FIG. 17, the distance D2 is more than the distance D1. However, the distance D2 may be less than the distance D1. Since the distance D1 differs from the distance D2, when viewed in the Z direction, the first connection conductor 51 and the second connection conductor 52 are located so as not to be symmetrical relative to the coil center point CP.

According to the modification example illustrated in FIG. 17, the distance D1 from the coil center line P0 to the first center line P1 in the Y direction differs from the distance D2 from the coil center line P0 to the second center line P2 in the Y direction. Thus, it is possible to easily form the inductor component 10 with a different inductance. Accordingly, it is possible to easily make fine adjustments to the inductance of the inductor component 10.

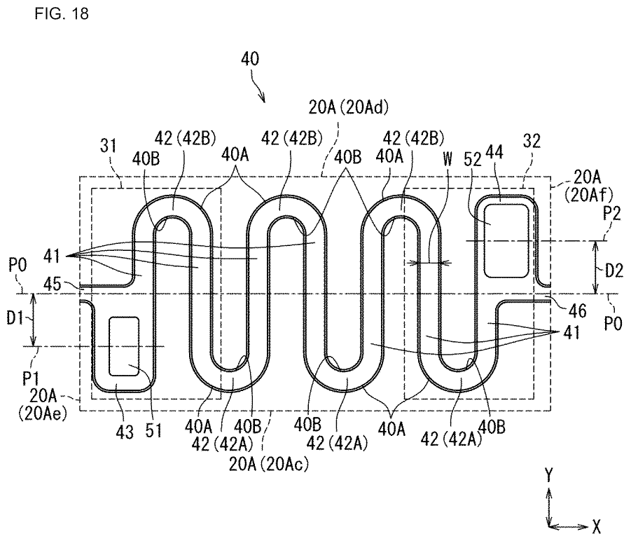

As illustrated in FIG. 18, when viewed in the Z direction, the size of the first connection conductor 51 may differ from the size of the second connection conductor 52. In the configuration illustrated in FIG. 18, the size of the first connection conductor 51 is smaller than the size of the second connection conductor 52. However, the size of the first connection conductor 51 may be larger than the size of the second connection conductor 52. Since the size of the first connection conductor 51 differs from the size of the second connection conductor 52 when viewed in the Z direction, the first connection conductor 51 and the second connection conductor 52 are located so as not to be symmetrical relative to the coil center point CP.

According to the modification example illustrated in FIG. 18, the size of the first connection conductor 51 differs from the size of the second connection conductor 52. Thus, it is possible to easily form the inductor component 10 with a different inductance. Accordingly, it is possible to easily make fine adjustments to the inductance of the inductor component 10.

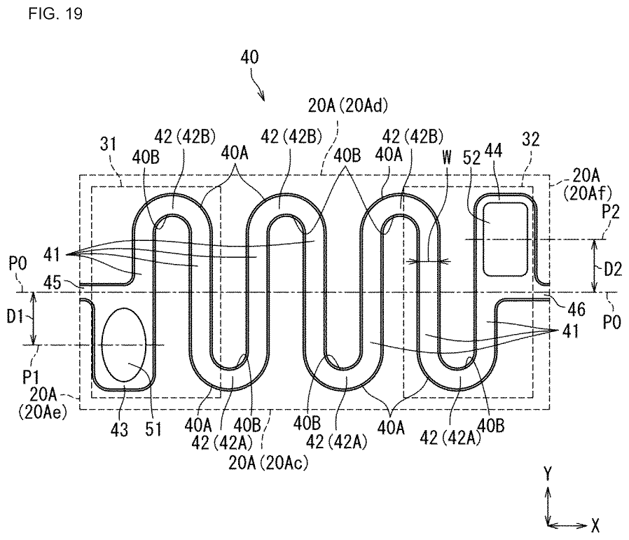

As illustrated in FIG. 19, when viewed in the Z direction, the shape of the first connection conductor 51 may differ from the shape of the second connection conductor 52. In the configuration illustrated in FIG. 19, when viewed in the Z direction, the shape of the first connection conductor 51 is an elliptical shape, and the shape of the second connection conductor 52 is a rectangular shape. The shape of each of the first connection conductor 51 and the second connection conductor 52 may be any shape. Since the shape of the first connection conductor 51 differs from the shape of the second connection conductor 52 when viewed in the Z direction, the first connection conductor 51 and the second connection conductor 52 are located so as not to be symmetrical relative to the coil center point CP.

According to the modification example illustrated in FIG. 19, the shape of the first connection conductor 51 differs from the shape of the second connection conductor 52. Thus, it is possible to easily form the inductor component 10 with a different inductance. Accordingly, it is possible to easily make fine adjustments to the inductance of the inductor component 10.

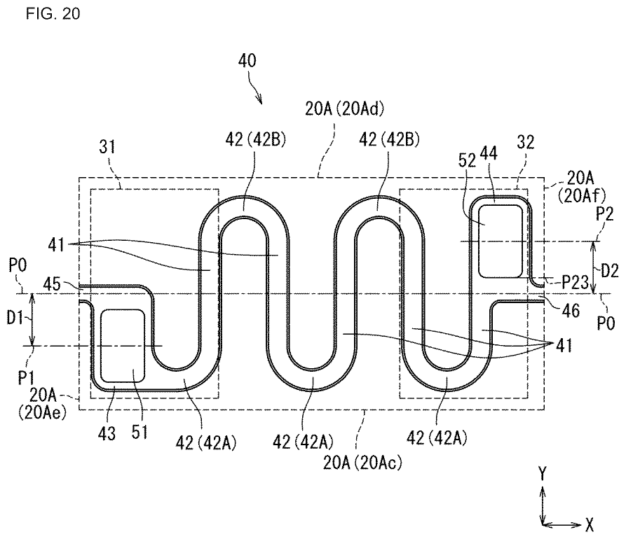

In the configuration illustrated in FIG. 2, the number of turns of the coil wiring line 40 on the same side of the coil center line P0 as the first center line P1 in the Y direction is equal to the number of turns of the coil wiring line 40 on the same side of the coil center line P0 as the second center line P2 in the Y direction. Specifically, in the configuration illustrated in FIG. 2, the number of turns of the coil wiring line 40 on each side of the coil center line P0 in the Y direction is three. However, the number of turns of the coil wiring line 40 on the same side of the coil center line P0 as the first center line P1 in the Y direction may differ from the number of turns of the coil wiring line 40 on the same side of the coil center line P0 as the second center line P2 in the Y direction. For example, in the configuration illustrated in FIG. 20, the number of turns of the coil wiring line 40 on the same side of the coil center line P0 as the first center line P1 in the Y direction is three, and the number of turns of the coil wiring line 40 on the same side of the coil center line P0 as the second center line P2 in the Y direction is two.

The inductor components described above can also be expressed as follows.

(1) An inductor component according to an aspect of the present disclosure, comprising a main body; a coil wiring line that is provided in the main body and that has a meandering shape meandering in a first direction and extending in a second direction crossing the first direction; a first external terminal and a second external terminal provided on an outer surface of the main body; a first connection conductor that is provided in the main body, that extends in a third direction crossing the first direction and the second direction, and that is connected to the first external terminal and the coil wiring line; and a second connection conductor that is provided in the main body, that extends in the third direction, and that is connected to the second external terminal and the coil wiring line. When viewed in the third direction, a coil center line is located between a first center line and a second center line, the coil center line being a center of the coil wiring line in the first direction and extending parallel to the second direction, the first center line being a center of the first connection conductor in the first direction and extending parallel to the second direction, and the second center line being a center of the second connection conductor in the first direction and extending parallel to the second direction.

(2) The inductor component according to (1), wherein when viewed in the third direction, the first connection conductor and the second connection conductor may be located outside the coil center line in the first direction.

(3) The inductor component according to (1) or (2), wherein when viewed in the third direction, the first connection conductor and the second connection conductor may be located so as to be symmetrical relative to a coil center point that is the center of the coil wiring line in the first direction and that is a center of the coil wiring line in the second direction.

(4) The inductor component according to (1) or (2), wherein when viewed in the third direction, the first connection conductor and the second connection conductor may be located so as not to be symmetrical relative to a coil center point that is the center of the coil wiring line in the first direction and that is a center of the coil wiring line in the second direction.

(5) The inductor component according to (4), wherein a distance from the coil center line to the first center line in the first direction may differ from a distance from the coil center line to the second center line in the first direction.

(6) The inductor component according to (4) or (5), wherein when viewed in the third direction, a size of the first connection conductor may differ from a size of the second connection conductor.

(7) The inductor component according to any one of (4) to (6), wherein when viewed in the third direction, a shape of the first connection conductor may differ from a shape of the second connection conductor.

(8) The inductor component according to any one of (1) to (7), wherein a conductor end may be located between a first position and a second position in the first direction, the conductor end being located farther from the coil center line in the first direction of two ends of the first connection conductor in the first direction, the first position being located farthest from the coil center line in an outer peripheral edge of the coil wiring line on the same side of the coil center line as the conductor end, and the second position being located farthest from the coil center line in an inner peripheral edge of the coil wiring line on the same side of the coil center line as the conductor end.

(9) The inductor component according to any one of (1) to (7), wherein a conductor end and a position located farthest from the coil center line in an outer peripheral edge of the coil wiring line on the same side of the coil center line as the conductor end may be located at the same position or substantially the same position in the first direction, the conductor end being located farther from the coil center line in the first direction of two ends of the first connection conductor in the first direction.

(10) The inductor component according to any one of (1) to (9), wherein a maximum length of the first connection conductor in the first direction may be longer than a maximum length of the first connection conductor in the second direction.

(11) The inductor component according to any one of (1) to (10), wherein the number of turns of the coil wiring line on the same side of the coil center line as the first center line in the first direction may be equal to the number of turns of the coil wiring line on the same side of the coil center line as the second center line in the first direction.

(12) The inductor component according to any one of (1) to (11), wherein outer surfaces of the main body may include a first surface on which the first external terminal and the second external terminal are provided, the first surface facing one side in the third direction, and a second surface facing another side in the third direction, the coil wiring line being interposed between the first surface and the second surface. Also, a distance between the coil wiring line and the first surface in the third direction may be shorter than a distance between the coil wiring line and the second surface in the third direction.

(13) The inductor component according to any one of (1) to (12), wherein the main body may contain a magnetic material, and a median grain size of the magnetic material contained in the main body may be 10 (μm) or less.

(14) The inductor component according to any one of (1) to (13), wherein the main body may contain a magnetic material, the coil wiring line may include a plurality of extending portions, each of which extends in the first direction, and a turning portion connecting two adjacent extending portions of the plurality of extending portions, and a median grain size of the magnetic material contained in the main body may be ⅕ or less of a distance between the two adjacent extending portions in the second direction.

Freely selected embodiments of the various embodiments can be combined as appropriate. Thus, it is possible to achieve effects of the embodiments.

The present is fully described through the preferred embodiments with reference to the drawings as appropriate. However, it is obvious to those skilled in the art that various alterations and modifications thereof can be made. It should be understood that such alterations and modifications are included in the present without departing from the scope of the present as defined by the appended claims.

What is claimed is:

1. An inductor component comprising:
a main body;
a coil wiring line that is in the main body and that has a meandering shape meandering in a first direction and extending in a second direction crossing the first direction;
a first external terminal and a second external terminal on an outer surface of the main body;
a first connection conductor that is in the main body, that extends in a third direction crossing the first direction and the second direction, and that is connected to the first external terminal and the coil wiring line; and
a second connection conductor that is in the main body, that extends in the third direction, and that is connected to the second external terminal and the coil wiring line,
wherein when viewed in the third direction, a coil center line is between a first center line and a second center line, the coil center line being a center of the coil wiring line in the first direction and extending parallel to the second direction, the first center line being a center of the first connection conductor in the first direction and extending parallel to the second direction, and the second center line being a center of the second connection conductor in the first direction and extending parallel to the second direction.

2. The inductor component according to claim 1, wherein
when viewed in the third direction, the first connection conductor and the second connection conductor are outside the coil center line in the first direction.

3. The inductor component according to claim 1, wherein
when viewed in the third direction, the first connection conductor and the second connection conductor are symmetrical relative to a coil center point that is the center of the coil wiring line in the first direction and that is a center of the coil wiring line in the second direction.

4. The inductor component according to claim 1, wherein
when viewed in the third direction, the first connection conductor and the second connection conductor are not symmetrical relative to a coil center point that is the center of the coil wiring line in the first direction and that is a center of the coil wiring line in the second direction.

5. The inductor component according to claim 4, wherein
a distance from the coil center line to the first center line in the first direction differs from a distance from the coil center line to the second center line in the first direction.

6. The inductor component according to claim 4, wherein
when viewed in the third direction, a size of the first connection conductor differs from a size of the second connection conductor.

7. The inductor component according to claim 4, wherein
when viewed in the third direction, a shape of the first connection conductor differs from a shape of the second connection conductor.

8. The inductor component according to claim 1, wherein
a conductor end is between a first position and a second position in the first direction, the conductor end being farther from the coil center line in the first direction of two ends of the first connection conductor in the first direction, the first position being farthest from the coil center line in an outer peripheral edge of the coil wiring line on the same side of the coil center line as the conductor end, and the second position being farthest from the coil center line in an inner peripheral edge of the coil wiring line on the same side of the coil center line as the conductor end.

9. The inductor component according to claim 1, wherein
a conductor end and a position farthest from the coil center line in an outer peripheral edge of the coil wiring line on the same side of the coil center line as the conductor end are at the same position or substantially the same position in the first direction, the conductor end being farther from the coil center line in the first direction of two ends of the first connection conductor in the first direction.

10. The inductor component according to claim 1, wherein
a maximum length of the first connection conductor in the first direction is longer than a maximum length of the first connection conductor in the second direction.

11. The inductor component according to claim 1, wherein
a number of turns of the coil wiring line on the same side of the coil center line as the first center line in the first direction is equal to the number of turns of the coil wiring line on the same side of the coil center line as the second center line in the first direction.

12. The inductor component according to claim 1, wherein
outer surfaces of the main body include
a first surface on which the first external terminal and the second external terminal are present, the first surface facing one side in the third direction, and
a second surface facing another side in the third direction, the coil wiring line being interposed between the first surface and the second surface, and
a distance between the coil wiring line and the first surface in the third direction is shorter than a distance between the coil wiring line and the second surface in the third direction.

13. The inductor component according to claim 1, wherein
the main body includes a magnetic material, and
a median grain size of the magnetic material in the main body is 10 (μm) or less.

14. The inductor component according to claim 1, wherein
the main body includes a magnetic material,
the coil wiring line includes a plurality of extending portions, each of which extends in the first direction, and a turning portion connecting two adjacent extending portions of the plurality of extending portions, and
a median grain size of the magnetic material in the main body is ⅕ or less of a distance between the two adjacent extending portions in the second direction.

15. The inductor component according to claim 2, wherein
when viewed in the third direction, the first connection conductor and the second connection conductor are symmetrical relative to a coil center point that is the center of the coil wiring line in the first direction and that is a center of the coil wiring line in the second direction.

16. The inductor component according to claim 2, wherein
when viewed in the third direction, the first connection conductor and the second connection conductor are not symmetrical relative to a coil center point that is the center of the coil wiring line in the first direction and that is a center of the coil wiring line in the second direction.

17. The inductor component according to claim 2, wherein
a conductor end is between a first position and a second position in the first direction, the conductor end being farther from the coil center line in the first direction of two ends of the first connection conductor in the first direction, the first position being farthest from the coil center line in an outer peripheral edge of the coil wiring line on the same side of the coil center line as the conductor end, and the second position being farthest from the coil center line in an inner peripheral edge of the coil wiring line on the same side of the coil center line as the conductor end.

18. The inductor component according to claim 2, wherein
a conductor end and a position farthest from the coil center line in an outer peripheral edge of the coil wiring line on the same side of the coil center line as the conductor end are at the same position or substantially the same position in the first direction, the conductor end being farther from the coil center line in the first direction of two ends of the first connection conductor in the first direction.

19. The inductor component according to claim 2, wherein
a maximum length of the first connection conductor in the first direction is longer than a maximum length of the first connection conductor in the second direction.

20. The inductor component according to claim 2, wherein
a number of turns of the coil wiring line on the same side of the coil center line as the first center line in the first direction is equal to the number of turns of the coil wiring line on the same side of the coil center line as the second center line in the first direction.
